(19) United States
(12) Patent Application Publication
(10) Pub. No.: US 2006/0177682 A1
(43) Pub. Date: Aug. 10, 2006

(54) Wooden slat structure for window blinds

(76) Inventor: Yu Chien Nien, Fuxing Shiang (TW)

Correspondence Address: TROXELL LAW OFFICE PLLC, SUITE 1404, 5205 LEESBURG PIKE, FALLS CHURCH, VA, 22041, US

(21) Appl. No.: 11/088,821

(22) Filed: Mar. 25, 2005

(30) Foreign Application Priority Data
Feb. 4, 2005 (TW) 094202151

(51) Int. Cl. B32B 21/04; B32B 27/42

(52) U.S. Cl. 428/528; 428/537.1

(57) ABSTRACT

A wooden slat structure for window blinds includes a slat having a set of upper and lower wrapping layers of normal wood to laminate a filling layer of recycled materials there-between wherein the filling layer can be made up of a plurality of recycled plate bodies, wood pieces, and sawdust that are firmly held together via adhesive agent to form a bonding layer at both upper and lower surfaces thereon for the secure attachment of the upper/lower wrapping layers thereto respectively. Then, the outer surfaces of the upper/lower wrapping layers are respectively processed to provide a smooth surface for a decorative layer made of a paint element, wood-patterned contact paper, or melamine coating to be levelly applied and coated thereon. Therefore, via the aforementioned structure, the wooden slat of the present invention can economically make the best use of recycled materials to achieve environmental protection as well as efficiently reduce the logging of woods to preserve natural resources for the future.

### BACKGROUND OF THE INVENTION

The present invention is related to a wooden slat structure for window blinds, including a slat equipped with a set of upper and lower wrapping layers of normal wood to laminate a filling layer of recycled materials such as recycled plate bodies, wood pieces, and sawdust there-between, a bonding layer formed at both upper and lower surfaces of the filling layer thereon for the secure attachment of the upper/lower wrapping layers thereto respectively, and a decorative layer coated at the outer surfaces of the upper/lower wrapping layers thereon respectively; whereby the slat structure thereof can economically make the best use of recycled materials to achieve environmental protection as well as efficiently reduce the logging of wood to preserve natural resources for the future.

Please refer to FIG. 1. A conventional wooden blind slat structure on the market comprises a slat 10 made of a single piece of solid wood that, manufactured by the logging of wood on a massive scale, can destroy the environment and exhaust the natural resources in the long run. Thus, the conventional blind slat structure is not only time-consuming in the processing thereof, but also quite unfriendly to the protection of environment as well as the preservation of nature resource thereof.

### SUMMARY OF THE PRESENT INVENTION

It is, therefore, the primary purpose of the present invention to provide a wooden slat structure for window blinds, including a slat equipped with a set of upper and lower wrapping layers of normal wood to laminate a filling layer of recycled materials there-between wherein the filling layer can be made up of recycled plate bodies, wood pieces and sawdust, economically making the best use of recycled materials to achieve environmental protection as well as efficiently reducing the logging of wood to preserve natural resources for the future.

### BRIEF DESCRIPTION OF THE DRAWINGS

FIG. 1 is a perspective view of a conventional wooden blind slat structure.

FIG. 2 is a perspective view of the present invention in the status of half assembly.

FIG. 3 is a cross sectional view of the present invention according to FIG. 2.

FIG. 4 is a perspective view of a molded slat of the present invention.

FIG. 5 is a perspective view of another molded slat of the present invention.

FIG. 6 is a perspective view of a third molded slat of the present invention.

FIG. 7 is a cross sectional view of another filling layer of the present invention.

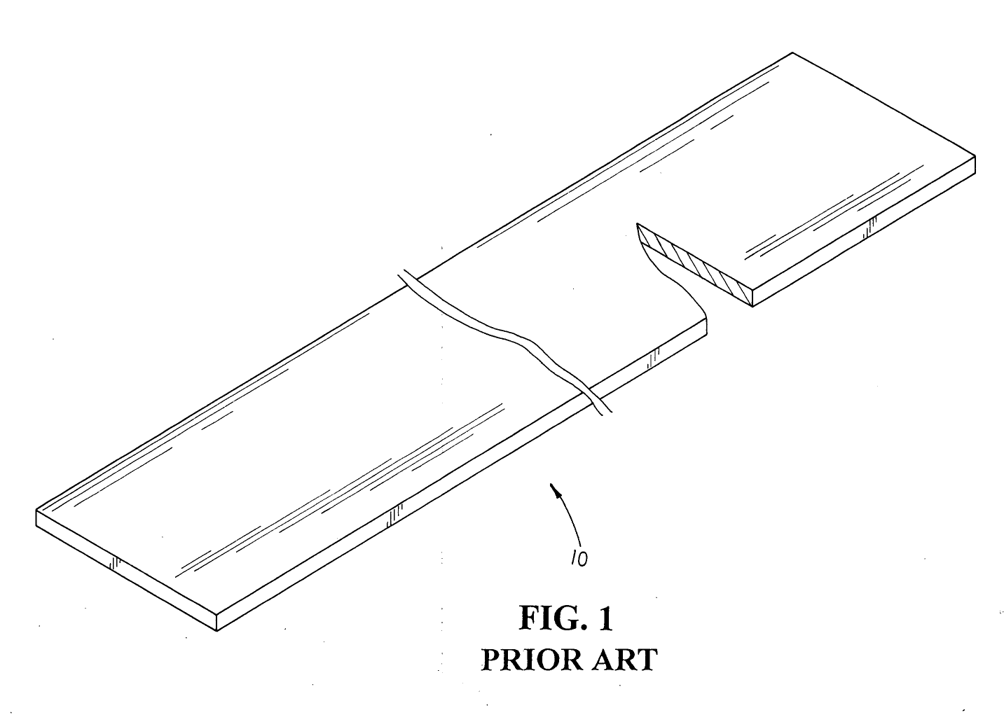

### DETAILED DESCRIPTION OF THE PREFERRED EMBODIMENTS

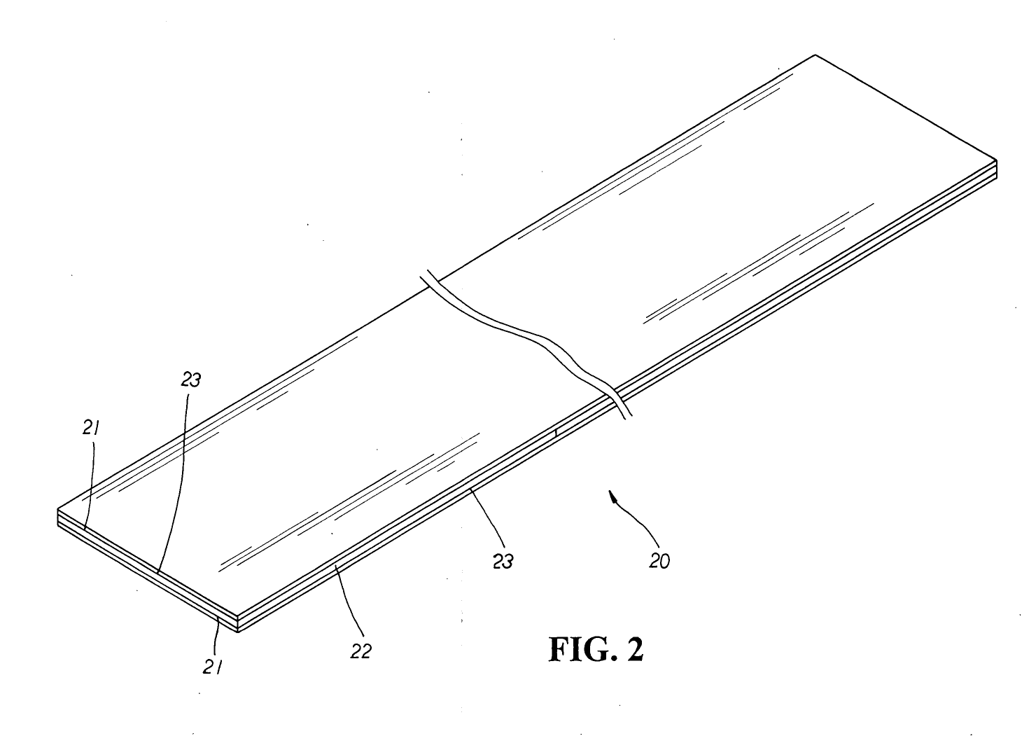

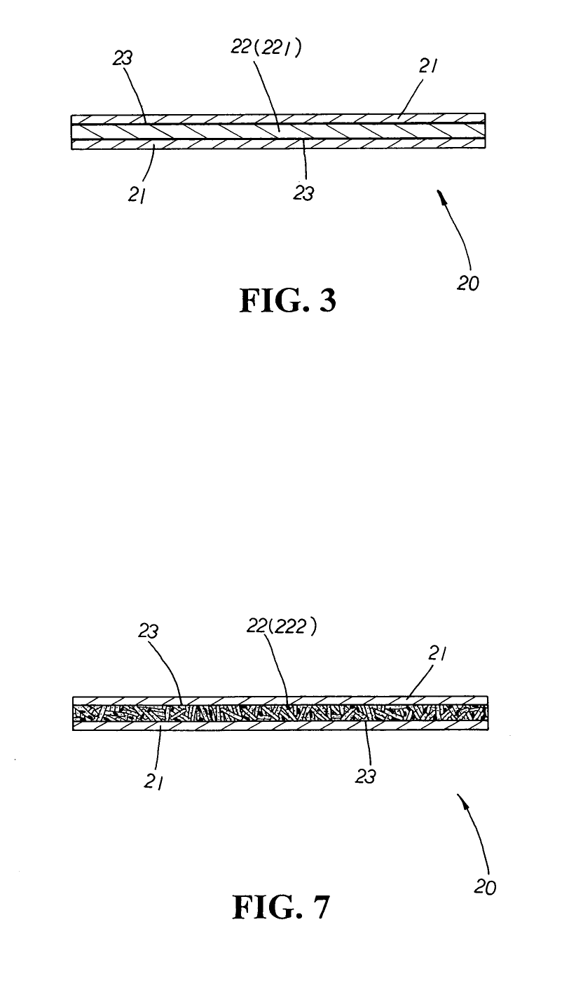

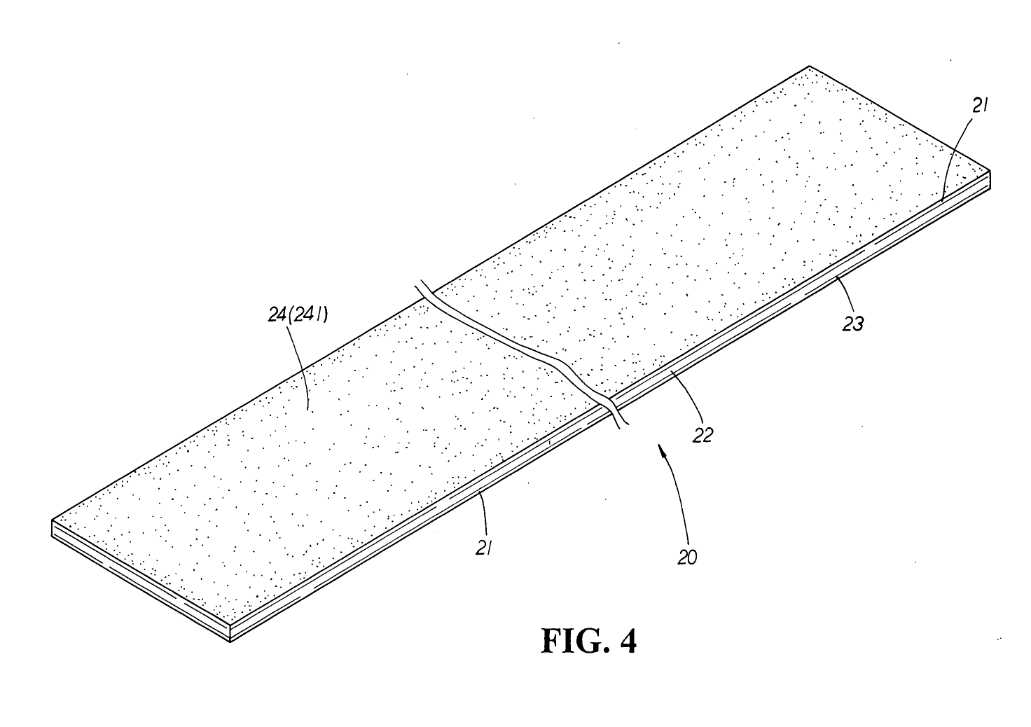

Please refer to FIG. 2. The present invention is related to a wooden slat structure for window blinds, including a slat 20 equipped with a set of upper and lower wrapping layers 21 of normal wood to laminate a filling layer of recycled materials 22 there-between wherein the filling layer 22 can be made up of a plurality of recycled plate bodies 221 as shown in FIG. 3 that are firmly held together via adhesive agent to form a bonding layer 23 at both upper/lower surfaces thereon for the secure attachment of the upper and lower wrapping layers 21 thereto respectively. The outer surfaces of the upper and lower wrapping layers 21 are respectively processed to provide a smooth surface for a decorative layer 24 like a paint element 241 to be levelly applied and coated thereon wherein the paint element 241 can be made of lacquer as shown in FIG. 4. Therefore, via the filling layer 22 made of recycled materials, the slat 20 of the present invention can economically make the best use of recycled materials to achieve environmental protection as well as efficiently reduce the logging of wood to preserve nature resource for the future.

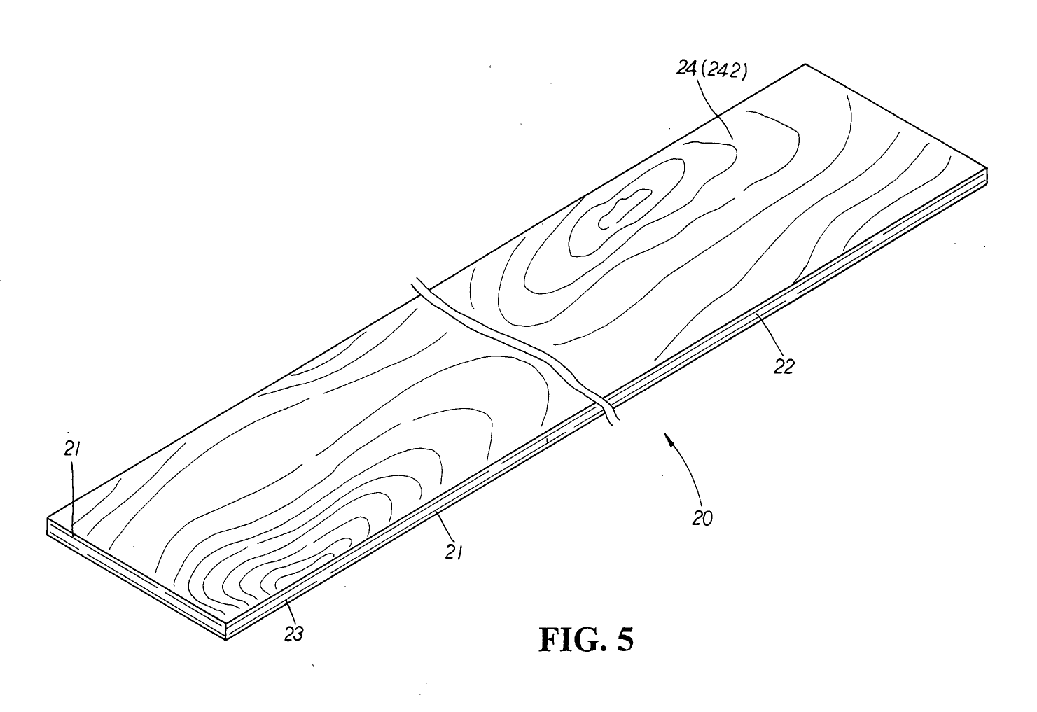

Please refer to FIG. 5 showing another molded slat of the present invention thereof. The decorative layer 24 applied onto the upper/lower wrapping layers 21 of the slat 20 thereon can also be made of wood-patterned contact paper 242 as shown in FIG. 5.

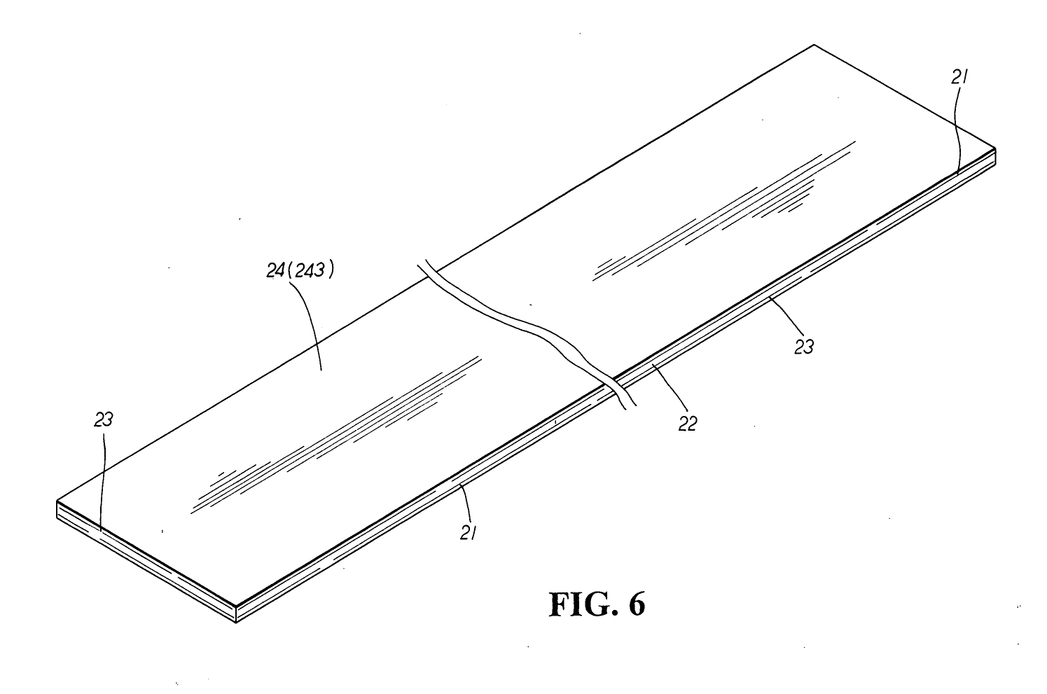

Please refer to FIG. 6 showing a third molded slat of the present invention thereof. The decorative layer 24 applied onto the upper/lower wrapping layers 21 of the slat 20 can also be made of melamine coating 243 as shown in FIG. 6.

Please refer to FIG. 7 showing a cross sectional view of another filling layer of the present invention. The filling layer 22 of the slat 20 can also be made up of recycled wood pieces and sawdust 222 or metallic pieces (non-illustrated in the diagram) that are integrally mixed and firmly held together via adhesive agent to form a bonding layer 23 at both upper and lower surfaces thereon for secure attachment of the upper and lower wrapping layers 21 thereto respectively.

What is claimed is:

1. A wooden slat structure for window blinds, including a slat equipped with a set of upper and lower wrapping layers to laminate a filling layer of recycled materials there-between, a bonding layer formed at the upper and lower surfaces of the filling layer thereon for the secure attachment of the upper and lower wrapping layers thereto respectively, and a decorative layer coated at the outer surfaces of the upper and lower wrapping layers thereon respectively; therefore, the wooden slat structure of the present invention can economically make the best use of recycled materials to achieve environmental protection as well as efficiently reduce the logging of woods to preserve natural resources for the future.

2. The wooden slat structure for window blinds as claimed in claim 1 wherein the upper/lower wrapping layers thereof can be made of normal wood.

3. The wooden slat structure for window blinds as claimed in claim 1 wherein the outer surfaces of the upper/lower wrapping layers are respectively processed to provide a smooth surface for the decorative layer to be levelly applied and coated thereon.

4. The wooden slat structure for window blinds as claimed in claim 1 wherein the filling layer thereof can be made of recycled plate bodies.

5. The wooden slat structure for window blinds as claimed in claim 1 wherein the filling layer thereof can also be made of recycled wood pieces and sawdust.

6. The wooden slat structure for window blinds as claimed in claim 1 wherein the filling layer thereof can also be made of metallic pieces.

7. The wooden slat structure for window blinds as claimed in claim 1 wherein the bonding layer thereof can be made of adhesive agent to be firmly fastened with the upper/lower wrapping layers thereby.

8. The wooden slat structure for window blinds as claimed in claim 1 wherein the decorative layer can be made of a paint element.

9. The wooden slat structure for window blinds as claimed in claim 1 wherein the decorative layer thereof can also be made of wood-patterned contact paper.

10. The wooden slat structure for window blinds as claimed in claim 1 wherein the decorative layer thereof can also be made of melamine coating.

11. The wooden slat structure for window blinds as claimed in claim 8 wherein the paint element of the decorative layer thereof can also be made of lacquer.
